(19) United States
(12) Patent Application Publication
(10) Pub. No.: US 2012/0306307 A1
(43) Pub. Date: Dec. 6, 2012

(54) MOTOR

(75) Inventor: Young Tae Kim, Seoul (KR)

(73) Assignee: SAMSUNG ELECTRO-MECHANICS, Suwon (KR)

(21) Appl. No.: 13/486,704

(22) Filed: Jun. 1, 2012

(30) Foreign Application Priority Data
Jun. 3, 2011 (KR) 10-2011-0053959

(51) Int. Cl. H02K 21/12

(52) U.S. Cl. 310/156.01

(57) ABSTRACT

There is provided a motor including: a stationary member including a core having a coil wound therearound and generating rotation force; and a rotating member including a magnet facing the coil so as to be rotatable with respect to the stationary member, wherein the rotating member rotates while descending by thrust dynamic pressure directed downwardly in an axial direction and generated in the rotating member when power is applied to the coil.

### CROSS-REFERENCE TO RELATED APPLICATIONS

This application claims the priority of Korean Patent Application No. 10-2011-0053959 filed on Jun. 3, 2011, in the Korean Intellectual Property Office, the disclosure of which is incorporated herein by reference.

### BACKGROUND OF THE INVENTION

1. Field of the Invention

The present invention relates to a motor, and more particularly, to a motor capable of being used in a recording disk driving device rotating a recording disk.

2. Description of the Related Art

A hard disk drive (HDD), an information storage device, reads data stored on a disk or writes data to a disk using a read/write head.

The hard disk drive requires a disk driving device capable of driving the disk. As the disk driving device, a spindle motor is used.

In the small-sized motor, a fluid dynamic pressure bearing assembly has been used. A shaft, a rotating member of the fluid dynamic pressure bearing assembly, and a sleeve, a stationary member thereof, include oil interposed therebetween, such that the shaft is supported by fluid pressure generated by the oil.

The small-sized motor according to the related art requires a predetermined flotation force for the rotation of the rotating member. In this case, in order to prevent the rotating member from being excessively floated due to the generation of a force greater than flotation force required for the rotation of the rotating member, a pulling plate is coupled to an area corresponding to a magnet to thereby suppress the flotation force.

However, in this case, there is a limitation in providing a constant pulling force based on a shaft in view of characteristics of a process thereof. Therefore, a phenomenon in which the rotating member rotates while being eccentric with regard to the stationary member has not been completely solved.

In addition, a case in which the pulling plate provided in order to prevent excessive floating of the rotating member separates from a base due to an external impact, or the like, may occur, thereby causing a fatal defect in the performance of the motor.

In addition, the coupling of the pulling plate causes a reduced thickness of the base, thereby having an influence on the strength of the base.

Therefore, in a motor of a recording disk driving device, research into a new shaft system suppressing excessive floating of a rotating member to thereby improve performance and a lifespan of the motor has been urgently required.

### SUMMARY OF THE INVENTION

An aspect of the present invention provides a motor having a shaft system structure capable of preventing excessive floating of a rotating member without a separate member therefor and improving strength of a stationary member to thereby improve a performance and a lifespan of the motor.

According to an aspect of the present invention, there is provided a motor including: a stationary member including a core having a coil wound therearound and generating rotation force; and a rotating member including a magnet facing the coil so as to be rotatable with respect to the stationary member, wherein the rotating member rotates while descending by thrust dynamic pressure directed downwardly in an axial direction and generated in the rotating member when power is applied to the coil.

The rotating member may include a shaft and a thrust plate coupled to a lower portion of the shaft, and the stationary member may include a sleeve supporting the shaft and a base having the core coupled thereto; and the thrust plate and the sleeve may be maintained in a state in which they contact each other when the rotating member is stationary.

The thrust plate and the sleeve may be maintained in the state in which they contact each other when the rotating member is stationary by magnetic attractive force directed upwardly in the axial direction and having a force greater than that exerted by a weight of the rotating member in a relationship between the magnet and the core.

The center of the magnet may be disposed in a position lower than that of the core in the axial direction.

The rotating member may include a shaft and a thrust plate coupled to a lower portion of the shaft, and the stationary member may include a sleeve supporting the shaft and a base having the core coupled thereto; and the rotating member rotates while descending by thrust dynamic pressure directed downwardly in the axial direction and acting on the thrust plate due to oil filling a clearance between the thrust plate and the sleeve.

The thrust dynamic pressure acting on the thrust plate may be formed by a thrust dynamic pressure part formed in at least one of an upper surface of the thrust plate and a bottom surface of the sleeve corresponding to the upper surface of the thrust plate.

The thrust dynamic pressure part may pump the oil filling the clearance between the thrust plate and the sleeve in an inner diameter direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor according to an embodiment of the present invention;

FIG. 2 is a schematic cross-sectional view showing a stationary state of a motor according to an embodiment of the present invention;

FIG. 3 is a schematic cross-sectional view showing a position relationship between a core and a magnet included in a motor according to an embodiment of the present invention;

FIG. 4 is a schematic cross-sectional view showing a rotational state of a motor according to an embodiment of the present invention; and

FIG. 5 is a schematic cut-away bottom perspective view showing a sleeve included in a motor according to an embodiment of the present invention.

### DETAILED DESCRIPTION OF THE PREFERRED EMBODIMENT

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

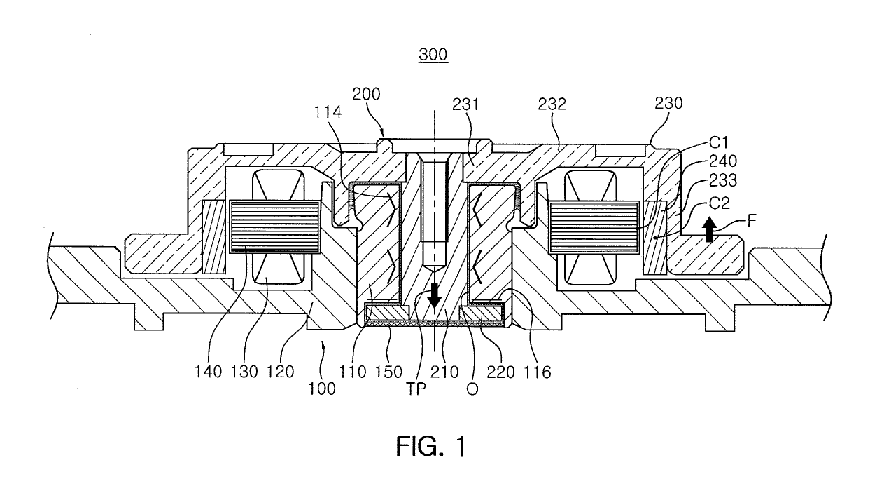

FIG. 1 is a cross-sectional view schematically showing a motor according to an exemplary embodiment of the present invention.

Referring to FIG. 1, a motor 300 according to an embodiment of the present invention may include a stationary member 100 including a sleeve 110 and a base 120 and a rotating member 200 rotating while descending with respect to the stationary member 100.

The stationary member 100 may include the sleeve 110 supporting a shaft 210, the base 120 including a core 140 coupled thereto, and all components rotating while descending except for the rotating member 200, the core 140 including a coil 130 wound therearound.

The sleeve 110, a component supporting the shaft 210 which is a component of the rotating member 200, may support the shaft 210 in such a manner that an upper end of the shaft 210 protrudes upwardly in an axial direction, and may be formed by forging cooper (Cu) or aluminum (Al) or sintering a Cu—Fe based alloy powder or a SUS based power.

The sleeve 110 may include a shaft hole having the shaft 210 inserted thereinto so as to have a micro clearance between the sleeve 110 and shaft 210. The micro clearance may include oil O filled therein to thereby stably support the shaft 210 by radial dynamic pressure due to the oil O.

Here, the radial dynamic pressure due to the oil O may be generated by a radial dynamic pressure part 114 formed as a groove in an inner peripheral surface of the sleeve 110. The radial dynamic pressure part 114 may have one of a herringbone shape, a spiral shape, and a screw shape.

However, the radial dynamic pressure part 114 is not limited to being formed in the inner peripheral surface of the sleeve 110 as described above but may also be formed in an outer peripheral surface of the shaft 210 which is the rotating member 200, and moreover, the number thereof is also not limited.

In addition, the sleeve 110 may include a thrust dynamic pressure part 116 (See FIG. 5) formed in a bottom surface thereof, the thrust dynamic pressure part 116 pumping the oil O filling a clearance between the bottom surface of the sleeve 110 and a thrust plate 220, to be described later, in an inner diameter direction to thereby generate thrust dynamic pressure TP directed downwardly in the axial direction in the thrust plate 220 which is the rotating member 200.

The thrust dynamic pressure part 116 may have one of a herringbone shape, a spiral shape, and a screw shape, similar to the radial dynamic pressure part 114.

However, the thrust dynamic pressure 116 is not limited to being formed in the bottom surface of the sleeve 110 but may also be formed in an upper surface of the thrust plate 220 which is the rotating member 200.

Here, the sleeve 110 may include a base cover 150 disposed in a lower portion thereof in the axial direction, the base cover 150 being coupled to the sleeve 110 while having a clearance therewith, the clearance receiving the oil O therein.

The base cover 150 may receive the oil O in the clearance between the base cover 150 and the sleeve 110 to thereby serve as a bearing supporting a lower surface of the shaft 210.

In addition, the oil O may be continuously filled in the clearance between the shaft 210 and the sleeve 110, in a clearance between a hub 230 to be described below and the sleeve 110, and in a clearance between the base cover 150 and the shaft 210 and a thrust plate 220 to be described below, whereby a full-fill structure may be entirely formed.

The base 120, a component coupled to the sleeve 110 to thereby support rotation of the rotating member 200, may include the core 140 coupled thereto, the core 140 including the coil 130 wound therearound.

In other words, the base 120 may be the stationary member 100 that includes an insertion hole formed therein such that the sleeve 110 supporting the shaft 210 which is a shaft system of the motor 300 according to the embodiment of the present invention is coupled thereto. The base 120 may include the core 140 coupled thereto, the core 140 including the coil 130 wound therearound and generating electromagnetic force having a predetermined magnitude at the time of the application of power.

The base 120 may be coupled to the sleeve 110 and the core 140 by any one of an adhesive bonding method, a welding method, and a press-fitting method.

Here, a center C1 of the core 140 coupled to the base 120 may be disposed in a position higher than that of a center C2 of a magnet 240 coupled to the hub 230 in the axial direction. Therefore, in the hub 230, force F directed upwardly in the axial direction may be generated due to magnetic attractive force allowing the center C2 of the magnet 240 to coincide with the center C1 of the core 140.

The force F may allow the sleeve 110 and the thrust plate 220 coupled to the shaft 210 to be maintained in a state in which they contact each other when the motor 300 according to the embodiment of the present invention is stationary, to thereby allow the rotating member 200 to rotate while descending.

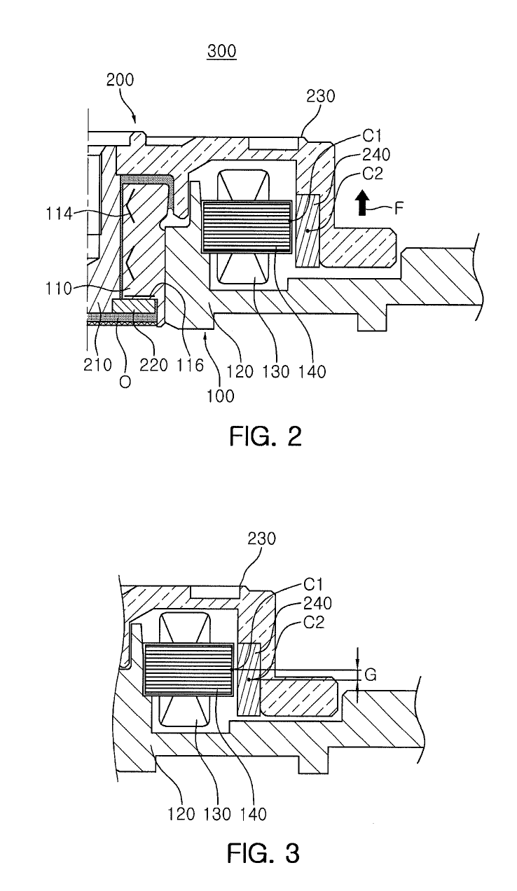

A detailed description thereof will be provided below with reference to FIGS. 2 through 5.

The rotating member 200 may include the shaft 210, the hub 230, and the thrust plate 220, and may include all components rotating while descending with respect to the stationary member 100.

First, the shaft 210 may be inserted into the shaft hole of the sleeve 110 so as to have the micro clearance between the sleeve 110 and shaft 210 to thereby rotate in the sleeve 110, and may include the hub 230 coupled to an upper portion thereof.

The hub 230 may be a rotating structure rotatably provided with respect to the stationary member 100 including the base 120 and may include the magnet 240 having an annular ring-shape (“annular ring-shaped magnet) and provided on an inner peripheral surface thereof, the annular ring-shaped magnet 240 corresponding to the core 140 while having a predetermined interval therewith, the core 140 including the coil 130 wound therearound.

Here, a structure of the hub 230 will be described in detail. The hub 230 may include a first cylindrical wall part 231 fixed to the upper end of the shaft 210, a disk part 232 extended from an end portion of the first cylindrical wall part 231 in an outer diameter direction, and a second cylindrical wall part 233 protruding downwardly from an end of the disk part 232 in the outer diameter direction. Here, the second cylindrical wall part 233 may include the magnet 240 coupled to an inner peripheral surface thereof.

The center C2 of the magnet 240 may be disposed in a position lower than that of the center C1 of the core 140 in the axial direction, the core 140 including the coil 130 wound therearound. Due to this configuration, in the hub 230, force F directed upwardly in the axial direction may be generated.

A detailed description thereof will be provided below with reference to FIGS. 2 through 5.

The thrust plate 220 may be coupled to a lower portion of the shaft 210 to thereby allow the rotating member 200 to rotate while descending.

Here, the thrust plate 220 may be coupled to the shaft 210 through adhesive bonding, welding, press-fitting, or the like, or be formed integrally with the shaft 210 rather than being formed as a member separated from the shaft 210.

Here, the thrust plate 220 may be maintained in a state of contact with the bottom surface of the sleeve 110 when the motor is stationary, and force allowing for the contact state may be generated by a difference G (See FIG. 3) in height between the center C1 of the core 140 and the center C2 of the magnet 240 coupled to the hub 230 as described above.

That is, since the center C2 of the magnet 240 coupled to the hub 230 is disposed in a position lower than that of the center C1 of the core 140, the force F directed upwardly in the axial direction may be continually generated in the hub 230 due to the magnetic attractive force between the magnet 240 and the core 140.

Therefore, when the motor 300 according to the embodiment of the present invention is stationary, the thrust plate 220 and the sleeve 110 may be maintained in a state in which they contact each other, and the force F due to the magnetic attractive force directed upwardly in the axial direction needs to be greater than the entire weight of the rotating member 200 including the shaft 210 and the hub 230.

In addition, when power is applied to the coil 130, the thrust plate 220 may pump the oil O filled between the thrust plate 220 and the sleeve 110 in the inner diameter direction by the thrust dynamic pressure part 116 to thereby allow the rotating member 200 including the thrust plate 220 to rotate while descending.

Here, the thrust dynamic pressure part 116 may be formed in the bottom surface of the sleeve 110 as shown in FIG. 1. However, the thrust dynamic pressure part 116 is not limited to being formed in the bottom surface of the sleeve 110 but may be formed in the upper surface of the thrust plate 220.

That is, when power is applied to the coil 130 in order to rotate the rotating member 200 of the motor 300 according to the embodiment of the present invention, the rotating member 200 including the thrust plate 220 may rotate.

Here, the oil O filled between the thrust plate 220 and the sleeve 110 may be pumped in the inner diameter direction by the thrust dynamic pressure 116 formed in at least one of the upper surface of the thrust plate 220 and the bottom surface of the sleeve 110 to thereby provide the thrust dynamic pressure TP directed downwardly in the axial direction to the thrust plate 220.

Therefore, when power is applied to the coil 130, the rotating member 200 including the shaft 210, the thrust plate 220, and the hub 230 may rotate while descending due to thrust dynamic pressure TP which is force acting on the thrust plate 220 and directed downwardly in the axial direction.

Here, at the time of rotation of the motor 300 according to the embodiment of the present invention, the force F generated upwardly in the axial direction due to a difference G (See FIG. 3) in position between the centers C1 and C2 of the core 140 and the magnet 240 may serve to prevent the rotating member 200 from rotating while excessively descending.

FIG. 2 is a schematic cross-sectional view showing a stationary state of a motor according to an embodiment of the present invention. FIG. 3 is a schematic cross-sectional view showing a position relationship between a core and a magnet included in a motor according to an embodiment of the present invention.

Referring to FIGS. 2 and 3, when the motor 300 according to the embodiment of the present invention is stationary, the upper surface of the thrust plate 220 which is the rotating member 200, and the bottom surface of the sleeve 110 which is the stationary member 100 may be maintained in a state in which they contact each other.

Here, the force allowing for the contact state of the thrust plate 220 and the sleeve 110 may be generated by the difference (G) in height between the center C1 of the core 140 coupled to the base 120 and the center C2 of the magnet 240 coupled to the hub 230.

That is, the center C2 of the magnet 240 may be disposed in a position lower than that of the center C1 of the core 140, such that the force F directed upwardly in the axial direction may be continually generated when the motor 300 according to the embodiment of the present invention rotates or is stationary. The force F may be greater than the weight of the rotating member 200.

Here, the weight of the rotating member 200 may includes weights of the shaft 210, the thrust plate 220, the hub 230, and all of rotating components such as a disk (not shown), a clamp (not shown) for fixing the disk (not shown), and the like, and the magnitude of the magnetic attractive force between the core 140 and the magnet 240 may be in proportion to a distance between the center C1 of the core 140 and the center C2 of the magnet 240.

Therefore, when the motor 300 according to the embodiment of the present invention is stationary, the upper surface of the thrust plate 220 and the bottom surface of the sleeve 110 are maintained in a state in which they contact each other, such that a clearance between an upper surface of the sleeve 110 and a bottom surface of the hub 230 is larger than a clearance therebetween when the motor 300 rotates.

In addition, due to the difference (G) in height between the center C2 of the magnet 240 and the center C1 of the core 140, the magnetic attractive force may continuously act even in the case in which the motor 300 according to the embodiment of the present invention rotates, and the force F of the hub 230 directed upwardly in the axial direction due to the magnetic attractive force may prevent the rotating member 200 from excessively descending.

In the motor included in the hard disk drive, the rotating member generally rotates while being floated upwardly in the axial direction. In this case, in order to prevent the excessive floating of the rotating member, a pulling plate, which is a separate member, is coupled to the base.

This pulling plate is formed as a separate member, thereby causing an increase in cost of the motor. In addition, in the case in which the pulling plate is coupled to the base, a coupling part needs to be formed in the base, thereby having a negative influence on strength of the base.

However, in the motor 300 according to the embodiment of the present invention, a structure in which the rotating member 200 including the shaft 210 rotates while descending rather than being floated is used. In addition, a separate member such as the pulling plate for preventing the rotating member from rotating while excessively descending is not required.

That is, the excessive descent of the rotating member 200 may be solved only by the positions of the center C1 of the core 140 and the center C2 of the magnet 240, whereby an excellent effect in view of a manufacturing cost and strength of the base 120 may be generated.

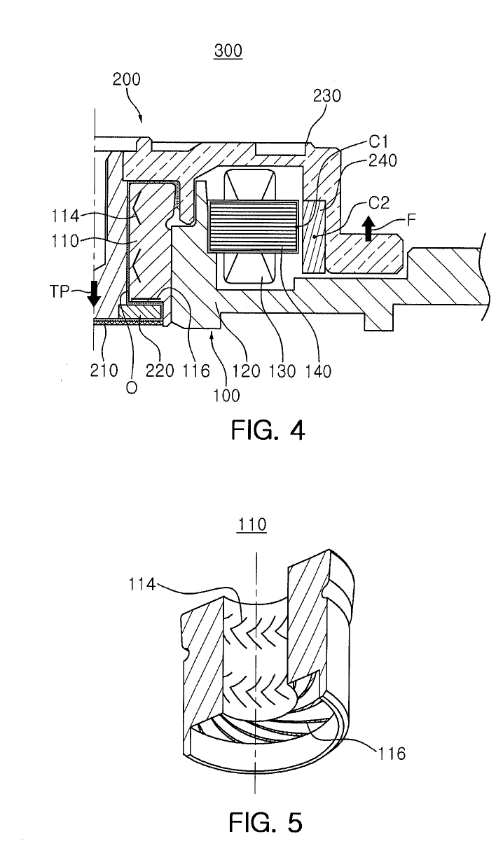

FIG. 4 is a schematic cross-sectional view showing a rotational state of a motor according to an embodiment of the present invention. FIG. 5 is a schematic cut-away bottom perspective view showing a sleeve included in a motor according to an embodiment of the present invention.

Referring to FIGS. 4 and 5, in the motor 300 according to an embodiment of the present invention, the rotating member 200 may rotate while descending.

When power is applied from the outside to the coil 130 in order to rotate the rotating member 200, the hub 230 rotates by electromagnetic interaction between the coil 130 and the magnet 240, and the shaft 210 coupled to the hub 230 and the thrust plate 220 also rotate accordingly.

In this case, the oil O filled between the upper surface of the thrust plate 220 and the bottom surface of the sleeve 110 may be pumped by the thrust dynamic pressure part 116 in the inner diameter direction.

Here, the thrust dynamic pressure part 116 may be formed in the bottom surface of the sleeve 110 as shown in FIG. 5. However, the thrust dynamic pressure part 116 is not limited to being formed in the bottom surface of the sleeve 110 but may be formed in the upper surface of the thrust plate 220.

In addition, the thrust dynamic pressure part 116 may be formed in both of the bottom surface of the sleeve 110 and the upper surface of the thrust plate 220. The formation positions and the number of the thrust dynamic pressure part 116 may be variously changed to be appropriate for the intention of a designer according to the magnitude of the thrust dynamic pressure TP.

Here, the principle that the rotating member 200 of the motor 300 according to the embodiment of the present invention rotates while descending will be described in detail. The force directed downwardly in the axial direction is applied to the thrust plate 220 while the radial dynamic pressure is applied to the shaft 210 by the radial dynamic pressure part 114 formed in at least one of the shaft 210 and the sleeve 110.

In addition, the oil O filled between the thrust plate 220 and the sleeve 110 may be pumped by the thrust dynamic pressure part 116 in the inner diameter direction, such that the thrust dynamic pressure TP directed downwardly in the axial direction may be applied to the thrust plate 220.

Therefore, the thrust plate 220 rotates in a state in which the upper surface thereof is spaced apart from the bottom surface of the sleeve 110, such that the rotating member 200 may rotate while descending.

Here, the excessive descent of the rotating member 200 may be solved through the position relationship between the center C1 of the core 140 and the center C2 of the magnet 240, that is, a structure in which the center C2 of the magnet 240 is disposed in a position lower than that of the center C1 of the core 140 as described above.

In addition, since the center C2 of the magnet 240 is disposed in a position lower than that of the center C1 of the core 140, the force F directed upwardly in the axial direction may entirely act on the magnet 240, whereby the stationary member 100 may more stably support the rotating member 200.

Therefore, a phenomenon in which the rotating member 200 rotates while being eccentric from the center of the shaft may be prevented, whereby the motor 300 may be stably driven.

In the case of the motor according to the embodiments of the present invention, due to a new shaft system structure in which the rotating member 200 rotates while descending and a positional structure between the center C2 of the magnet 240 and the center C1 of the core 140, a phenomenon in which the rotating member 200 rotates while excessively descending may be prevented without using a separate member.

In addition, a phenomenon in which the rotating member 200 rotates while being eccentric from the center of the shaft may be prevented, and at the same time, the strength of the base 120 may be improved, whereby the motor may be stably driven.

As set forth above, with the motor according to the embodiments of the present invention, a phenomenon in which the rotating member rotates while being excessively descending could be prevented without using a separate member, and a phenomenon the rotating member rotates while being eccentric from the center of the shaft could be prevented.

In addition, the strength of the base, the stationary member, could be improved, whereby the motor can be stably driven and a lifespan thereof can be maximized.

While the present invention has been shown and described in connection with the embodiments, it will be apparent to those skilled in the art that modifications and variations can be made without departing from the spirit and scope of the invention as defined by the appended claims.

What is claimed is:

1. A motor comprising:
a stationary member including a core having a coil wound therearound and generating rotation force; and
a rotating member including a magnet facing the coil so as to be rotatable with respect to the stationary member,
wherein the rotating member rotates while descending by thrust dynamic pressure directed downwardly in an axial direction and generated in the rotating member when power is applied to the coil.

2. The motor of claim 1, wherein the rotating member includes a shaft and a thrust plate coupled to a lower portion of the shaft, and the stationary member includes a sleeve supporting the shaft and a base having the core coupled thereto, and
wherein the thrust plate and the sleeve are maintained in a state in which they contact each other when the rotating member is stationary.

3. The motor of claim 2, wherein the thrust plate and the sleeve are maintained in the state in which they contact each other when the rotating member is stationary by magnetic attractive force directed upwardly in the axial direction and having a force greater than that exerted by a weight of the rotating member in a relationship between the magnet and the core.

4. The motor of claim 2, wherein the center of the magnet is disposed in a position lower than that of the core in the axial direction.

5. The motor of claim 1, wherein the rotating member includes a shaft and a thrust plate coupled to a lower portion of the shaft, and the stationary member includes a sleeve supporting the shaft and a base having the core coupled thereto, and
wherein the rotating member rotates while descending by thrust dynamic pressure directed downwardly in the axial direction and acting on the thrust plate due to oil filling a clearance between the thrust plate and the sleeve.

6. The motor of claim 5, wherein the thrust dynamic pressure acting on the thrust plate is formed by a thrust dynamic pressure part formed in at least one of an upper surface of the thrust plate and a bottom surface of the sleeve corresponding to the upper surface of the thrust plate.

7. The motor of claim 6, wherein the thrust dynamic pressure part pumps the oil filling the clearance between the thrust plate and the sleeve in an inner diameter direction.
